(19) United States
(12) Patent Application Publication
(10) Pub. No.: US 2011/0302220 A1
(43) Pub. Date: Dec. 8, 2011

(54) SQL PROCESSING FOR DATA CONVERSION

(76) Inventors: Albert Marcella, Tewksbury, MA (US); Gaetano Paladino, North Reading, MA (US)

(21) Appl. No.: 12/795,907

(22) Filed: Jun. 8, 2010

(51) Int. Cl. G06F 17/30

(52) U.S. Cl. 707/803; 707/E17.006

(57) ABSTRACT

A system includes reception of a structured query language (SQL) query to select one or more values from one or more database tables, modification of the SQL query to select identifiers of table rows including the selected values, reception of query results of the modified SQL query, the query results including the selected values and identifiers of table rows including the selected values, determination of converted values corresponding to one or more of the selected values based on the identifiers of table rows including the one or more of the selected values, and modification of the query results to substitute each of the one or more of the selected values with a corresponding substitute value.

### BACKGROUND

A typical enterprise software system includes a data layer to store business-related data and an application layer. The application layer receives requests from consumers and, in response, retrieves the stored data, applies any required business logic thereto, and provides results to the consumers.

An enterprise software system may be designed to store, process and provide data in a particular format (e.g., language, currency, date/time format, etc.). However, the system may be later required to support other data formats (e.g., after acquisition of the system by a multinational corporation). The addition of such support currently requires significant modification of the application layer and of the database schema underlying the data layer. These modifications are costly and may introduce instability into the system.

Systems are desired to efficiently support different data formats in a database-driven computing system. Also desired are such systems which may be efficiently incorporated into an existing computing system.

### BRIEF DESCRIPTION OF THE DRAWINGS

FIG. 1 is a block diagram of a system according to some embodiments.

FIG. 2 is a block diagram of an apparatus according to some embodiments.

FIG. 3 illustrates a flow diagram of a process according to some embodiments.

FIG. 4 is a tabular representation of a portion of a database structure according to some embodiments.

FIG. 5 is a tabular representation of a portion of a translation table according to some embodiments.

FIG. 6 illustrates a flow diagram of a process according to some embodiments.

FIGS. 7A and 7B illustrate a flow diagram of a process according to some embodiments.

FIG. 8 is a block diagram of a system according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

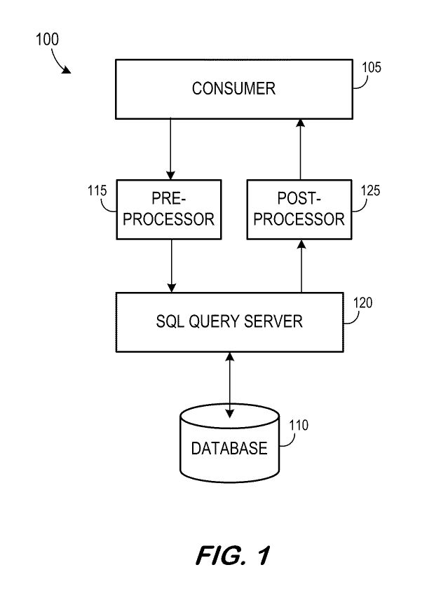

FIG. 1 is a block diagram of system 100 according to some embodiments. The elements of system 100 may operate to support multiple data formats. In one example, system 100 may convert data stored in one language to a second language. Embodiments are not limited to this example.

System 100 includes consumer 105, database 110, pre-processor 115, Structured Query Language (SQL) server 120, and post-processor 125. Each element of system 100 may be implemented by any suitable combination of hardware (e.g., one or more processors) and/or software (e.g., processor-executable program code). System 100 may include elements in addition to those illustrated, and some embodiments may omit one or more elements of system 100.

Briefly, consumer 105 may transmit an SQL query in order to retrieve data from database 110. The SQL query may be received by pre-processor 115 and modified thereby. SQL query server 120 receives the modified query and queries database 110 based on the modified query. SQL query server 120 returns results of the query to post-processor 125. Post-processor 125 may convert one or more values of the results to a different format and then returns the results, including the converted value(s), to consumer 105. Detailed explanations of the foregoing according to some embodiments are provided below.

Consumer 105 may comprise any apparatus and/or application for providing an SQL query. Consumer 105 may comprise a database application which provides such a query based on a request received from a client application (not shown) operated by a user. Some embodiments include a presentation layer between a client application and a database application to provide additional functionality related to presentation of the requested data.

Database 110 may comprise any query-responsive data source. Embodiments may comprise more than one of such data sources. Database 110 may store data in database tables according to an underlying database schema. The stored data may be received from disparate sources (not shown).

Although illustrated separately, one or both of pre-processor 115 and post-processor 125 may comprise elements of consumer 105 and/or SQL query server 120. In some embodiments, pre-processor 115 and post-processor 125 may be inserted into an existing system comprising consumer 105, SQL query server 120 and database 110 to provide functionality as described herein without requiring changes to consumer 105, SQL query server 120 and database 110.

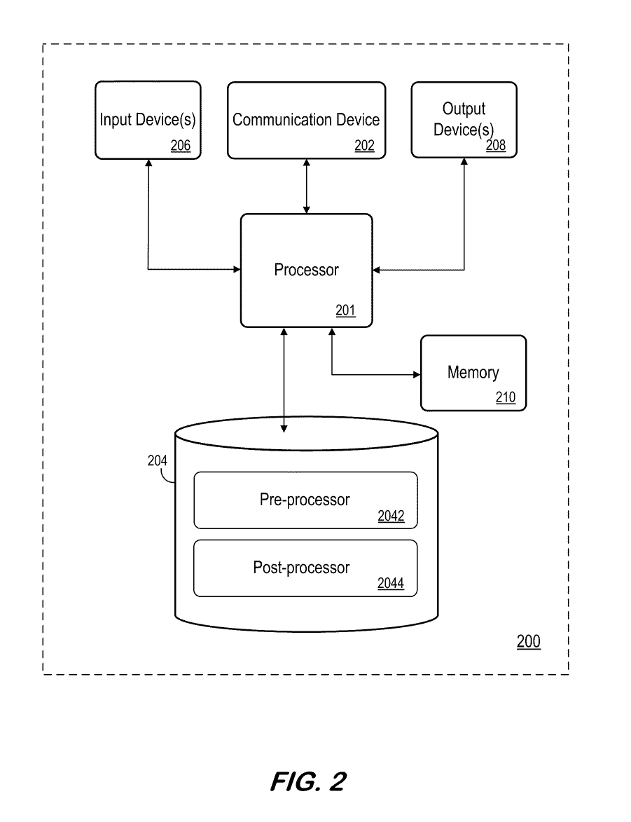

FIG. 2 is a block diagram of apparatus 200 according to some embodiments. Apparatus 200 may comprise a general-purpose computing apparatus and may perform the functions attributed herein to pre-processor 115 and to post-processor 125. Apparatus 200 may include other unshown elements according to some embodiments.

Apparatus 200 includes processor 201 operatively coupled to communication device 202, data storage device 204, one or more input devices 206, one or more output devices 208 and memory 210. Communication device 202 may facilitate communication with external devices. Input device(s) 206 may comprise, for example, a keyboard, a keypad, a mouse or other pointing device, a microphone, knob or a switch, an infra-red (IR) port, a docking station, and/or a touch screen. Input device(s) 206 may be used, for example, to enter information into apparatus 200. Output device(s) 208 may comprise, for example, a display (e.g., a display screen) a speaker, and/or a printer.

Data storage device 204 may comprise any appropriate persistent storage device, including combinations of magnetic storage devices (e.g., magnetic tape, hard disk drives and flash memory), optical storage devices, Read Only Memory (ROM) devices, etc., while memory 208 may comprise Random Access Memory (RAM).

Pre-processor 2042 of data storage device 204 includes program code for execution by processor 200 to provide functions attributed herein to a pre-processor. Similarly, pre-processor 2044 of data storage device 204 includes program code which is executable to provide functions attributed herein to a post-processor. Embodiments are not limited to execution of these functions by a single apparatus.

Data storage device 204 may also store data and other program code for providing additional functionality and/or which are necessary for operation thereof, such as device drivers, operating system files, etc.

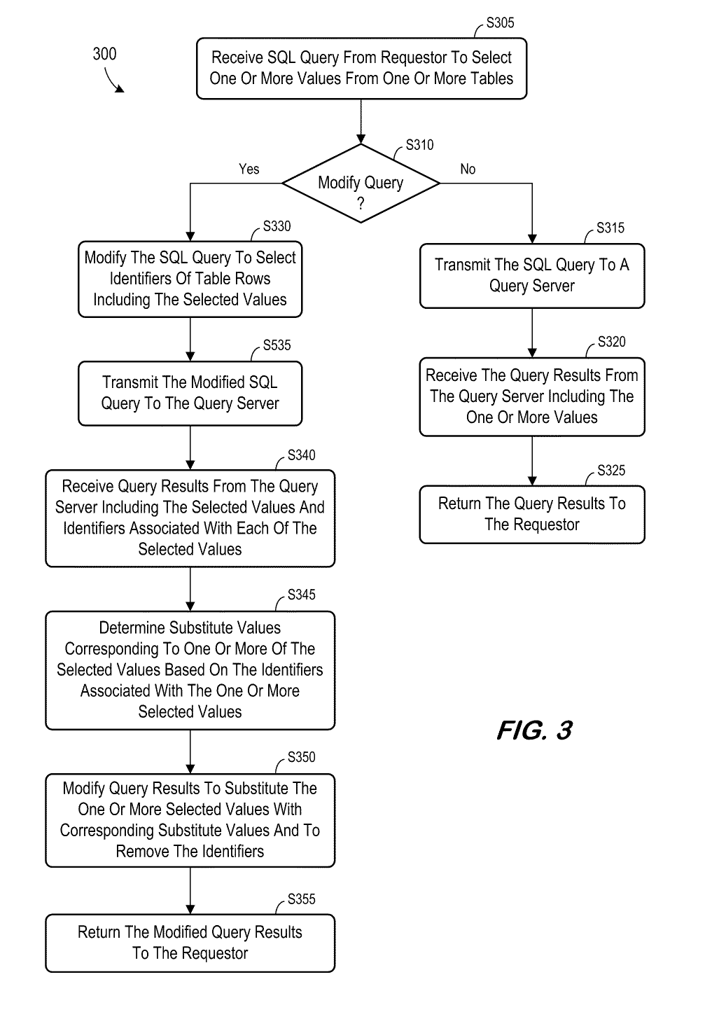

FIG. 3 is a flow diagram of process 300 according to some embodiments. Process 300 may be used to convert query results from one format to another format, without requiring substantial modification (if any) to an existing query generator, query server, and database.

Process 300, and all other processes described herein, may be executed by computer hardware and/or embodied in program code stored on a tangible computer-readable medium. Process 300 may be performed by pre-processor 115 and post-processor 125 of system 100 and/or by an apparatus such as apparatus 200, but embodiments are not limited thereto.

Initially, at S305, an SQL query is received from a requestor such as consumer 105 of system 100. The SQL query may be generated by the requestor or by another entity in any context and for any purpose. The SQL query is generated based on metadata describing the columns of stored database tables, and is to select one or more stored values from one or more of the database tables.

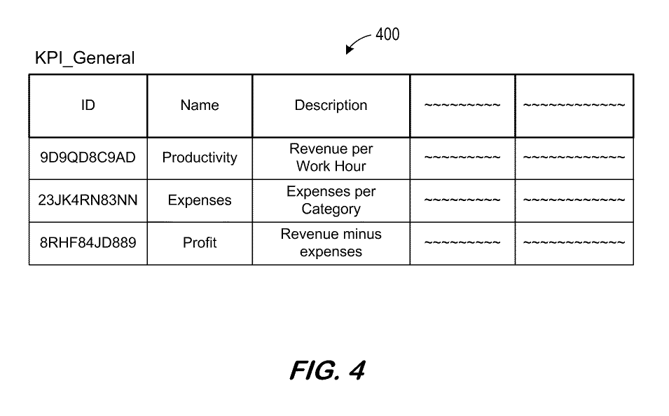

FIG. 4 illustrates a tabular representation of a portion of a KPI_General database table 400 for purposes of example. Table 400 may be stored in database 110 according to the particular storage protocol governing database 110. Table 400 includes several columns, and each row of table 400 associates a value with each column. Each value of the ID column identifies the respective row in which the value resides. For example, ID “9D9QD8C9AD” identifies the first row of table 400.

In some embodiments of S305, the received SQL query selects one or more values from table 400. For example, the received SQL query may read:

### SELECT DESCRIPTION

### FROM KPI_GENERAL

### WHERE NAME=‘PRODUCTIVITY’

This example specifies only a single column of a single database table, but embodiments may support queries of multiple tables and/or of multiple columns of a single database table.

The query may be received by pre-processor 115 at S305. Next, at S310, it is determined whether the query should be modified. According to some embodiments, S310 comprises initially determining whether a format (e.g., language, currency, date/time format, etc.) associated with the current user (i.e., the person under whose security profile the query is being executed) matches the system default format. If a match is determined, flow continues to S315. If a match is not determined (e.g., the current user's specified language is German and the systems default language is English), additional checks may be performed to determine whether the query should be modified.

For example, if process 300 is intended to convert retrieved values from one language to another, and if none of the columns specified in the query are of type String, it may be determined at S310 to not modify the query. In another example, it may be determined to not modify the query if the query does not retrieve actual stored data (e.g., SELECT COUNT (*) FROM KPI_GENERAL). Some embodiments may determine to not modify the query if the data of the queried tables is determined to be already in the desired format. Any suitable reason for modifying/not modifying the query may be considered at S310.

If it is determined that the query should not be modified, process 300 continues to fulfill the query as is known in the art. First, flow continues to S315 to transmit the received SQL query to a query server. In some embodiments, a pre-processor executing process 300 may perform additional actions related to the query (e.g., logging, auditing, etc.) prior to transmitting the query to a query server at S315. Also, the query may be received by an intermediate entity for further processing after being transmitted from the pre-processor and before being received by the query server.

Query results are received from the query server at S320. The query results include the one or more values selected by the SQL query. Next, the query results are returned to the requestor.

Flow proceeds from S310 to S330 if it is determined that the query should be modified. The query is modified at S330 to select identifiers of table rows including the selected values. Such a modification may consist of adding the ID column of each of the database tables of the query to the SELECT statement. For example, the above-mentioned SQL query may be modified at S330 to read:

### SELECT DESCRIPTION, ID

### FROM KPI_GENERAL

### WHERE NAME=‘PRODUCTIVITY’

In a case that the query selects values from more than one database table (e.g., KPI_GENERAL, KPI_DETAILS), the added ID column may be prefaced with an identifier, such as:

### SELECT DESCRIPTION, REVISION_DATE, KPI_GENERAL.ID, KPI_DETAILS.ID

### FROM KPI_GENERAL, KPI_DETAILS

### WHERE NAME=‘PRODUCTIVITY’

As a result of the modification, the query results will consist of the selected values as well as identifiers of the actual stored table rows which include the selected values.

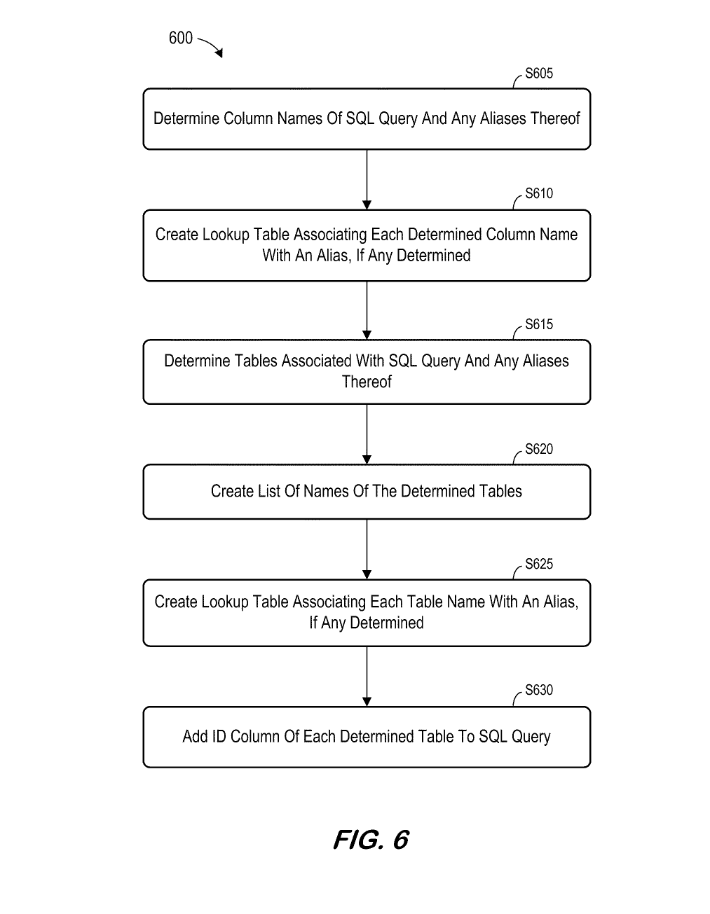

The received query may be more complex than the examples provided above. For example, the received query may comprise a union of several queries. In such a case, each of the several queries is modified independently as described above. Queries may also include aliases for column names and table names. A more detailed description of S330, which accounts for such aliases, is provided below with respect to FIG. 6.

The modified query is transmitted to the query server at S335 as described above with respect to S315. As described with respect to S320, corresponding query results are then received from the query server at S340. With reference to system 100, the query results may be received at S340 by post-processor 125. Post-processor 125 may therefore perform S345 through S355 according to some embodiments.

The received query results include the values selected by the modified SQL query. These values include the values selected by the originally-received SQL query and identifiers of the actual stored table rows which include the selected values. Returning to the first example query set forth above, the received results may include a single result row: ‘Revenue per Work Hour’, ‘9D9QD8C9AD’.

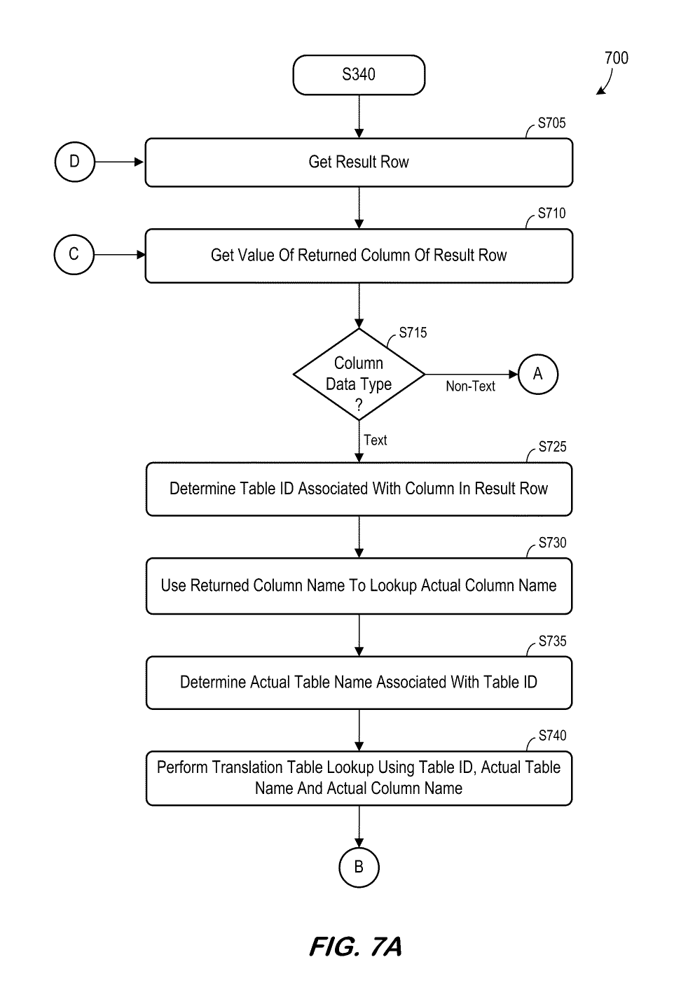

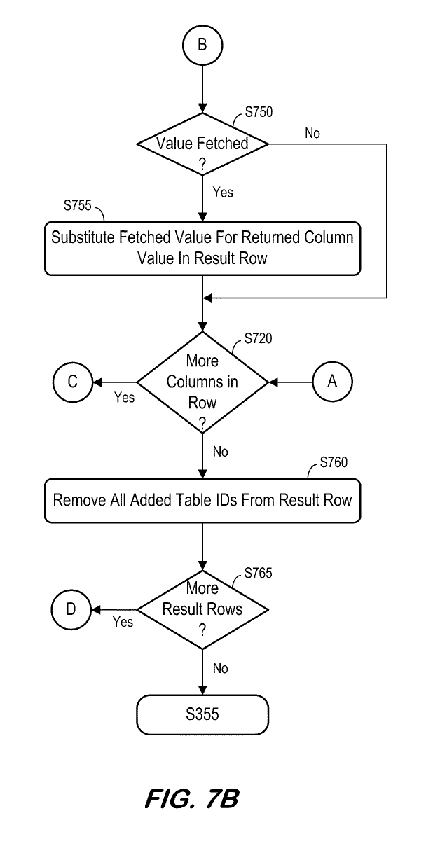

At S345, converted values corresponding to one or more of the selected values are determined. The converted values are determined based on the identifiers associated with the one or more selected values in the search results. According to some embodiments of S345, including the detailed embodiment described below with respect to FIGS. 7A and 7B, the identifier, column name, and table name associated with a returned value are used to lookup a converted value in a translation table.

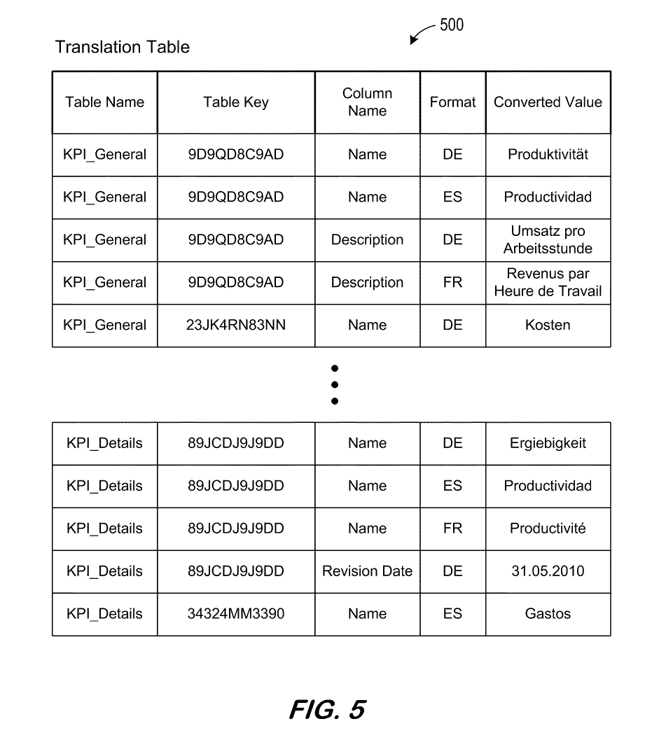

FIG. 5 illustrates a tabular representation of a portion of translation table 500 for purposes of example. Translation table 500 may be stored in the same database as the queried tables or in a separate data structure. Translation table 500 includes columns Table Name, Table Key, Column Name, Format and Converted Value. Therefore, each row of translation table 500 specifies, for a single alternate format, a converted value which corresponds to a value stored in a particular row and column of a particular table.

For example, the first two rows of translation table 500 specify converted values, in German and Spanish, respectively, which correspond to the value stored in the Name column of row 9D9QD8C9AD of the KPI_General table. The next two rows specify converted values, in German and French, respectively, which correspond to the value stored in the Description column of row 9D9QD8C9AD of the KPI_General table. The fifth row of translation table 500 specifies a converted value, in German, which corresponds to the value stored in the Name column of row 23JK4RN83NN of the KPI_General table.

In the present example, the received results include the values: ‘Revenue per Work Hour’, ‘9D9QD8C9AD’. The results also include metadata indicating the table name from which the results were obtained (i.e., KPI_General), and the name of the table column (i.e., Description, ID) associated with each value of the results. The received ID value (i.e., 9D9QD8C9AD), the table name (i.e., KPI_General), and the non-ID column name (i.e., Description), along with an indicator of the desired format (e.g., FR), are used to lookup a corresponding converted value in translation table 500. As shown in FIG. 5, the corresponding converted value in this example is ‘Revenus par Heure de Travail’.

The query results are modified to substitute the one or more selected values with the corresponding converted values at S350. According to some embodiments, the received ID values are also removed from the results at S350. Accordingly, at S350, the received results ‘Revenue per Work Hour’, ‘9D9QD8C9AD’ are modified to ‘Revenus par Heure de Travail’.

The modified results are returned to the requester (e.g., from post-processor 125 to consumer 105) at S355. It is noted that the results conform to the original SQL Query (SELECT DESCRIPTION FROM KPI_GENERAL WHERE NAME=‘PRODUCTIVITY’), and therefore it may not be necessary to modify the code of the requester to implement process 300 in an existing system.

FIG. 6 is a flow diagram of process 600 to implement S330 according to some embodiments.

Initially, it is noted that each of the following valid SQL queries selects identical data:

### SELECT NAME FROM MYTABLE

### SELECT NAME AS MYNAMEALIAS FROM MYTABLE

### SELECT M.NAME FROM MYTABLE M

SELECT M.NAME AS MYNAMEALIAS FROM MYTABLE M

Although the selected data is identical, the results returned by each query will differ. Specifically, the results of a query will include not only the selected data, but also the alias (if any) that the query gives to the column in which the selected data resides. However, as described above, some embodiments require the actual column name in order to perform a translation table lookup after receiving the query results. Processes 600 and 700 are intended to address this issue.

S605 includes a determination of the column names of the SQL query and any aliases thereof. For the first and third of the four “identical” SQL queries listed immediately above, the determined column name is Name and no aliases thereof exist. For the second and fourth queries, the determined column name is Name and the alias thereof is MyNameAlias.

A lookup table is created at S610. The lookup table associates each determined column name with an alias, if an alias of the column name was determined at S605. The lookup table may comprise any structure for associating two data values, including but not limited to a hashmap. According to some embodiments, the data structure exhibits the following structure:

### Key, Value

Key=alias or actual column name if no alias is determined
Value=actual column name

Therefore, for the first and third queries listed above, the lookup table would include the row (Name, Name). For the second and fourth queries listed above, the lookup table would include the row (MyNameAlias, Name). Of course, the lookup table would include additional rows for any other column names within the SQL query.

Next, at S615, all tables associated with the SQL query are determined, along with any aliases thereof. For example, the table MyTable would be determined for each of the above four queries, and the alias M would also be determined in the case of the third and fourth queries.

A list of the names of the determined tables is created at S620. With reference to the multiple-table query described above with respect to process 300, the list may comprise an array named tableList and having the following structure:

tableList[0]=“KPI_General”
tableList[1]=“KPI_Details” etc.

At S625, a second lookup table or other data structure is created. The lookup table associates each determined table name with an alias, if an alias of the table was determined at S615. Again, the lookup table may comprise any structure for associating two data values, including but not limited to a hashmap. According to some embodiments, the second data structure exhibits the following structure:

### Key, Value

Key=actual table name
Value=alias or actual table name if no alias is determined

For the first and second queries listed above, the lookup table would include the row (MyTable, MyTable). For the third and fourth queries listed above, the lookup table would include the row (MyTable, M). If the queries referenced any other tables, the lookup table would include and additional row for each of the other tables.

Next, at S630, an ID column of each determined table is added to the SQL query. A complete example of process 600 according to some embodiments will now be provided in order to illustrate some implementations of S630.

Given the received query:

### SELECT DESCRIPTION, REVISION_DATE

### FROM KPI_GENERAL as KPI, KPI_DETAILS

### WHERE NAME=‘PRODUCTIVITY’,

a pre-processor executing process 600 creates the following list at S620:
tableList[0]=“KPI_General”
tableList[1]=“KPI_Details”.

The pre-processor also creates the following lookup table at S625:

| Key | Value |
|---|---|
| KPI_General | KPI |
| KPI_Details | KPI_Details |

At S630, the list of table names is traversed to add an ID column for each listed table. Each added ID column must reference its corresponding table to avoid ambiguity. However, once an alias is defined for a table in an SQL statement, that alias must be used in every other reference to the table in the SQL statement. Accordingly, the name of each table is used to lookup a value in the lookup table created at S625. This lookup ensures that the ID column added for a table properly references the table alias if an alias was assigned to the table.

Moreover, each added ID column corresponding to a table in the list is assigned the alias AS ID_ADDED_n, where n is the index of the table name in the list. As will be described with respect to process 700, this alias will be used to facilitate removal of the corresponding table IDs from the query results. Continuing the above example, the query appears as follows after S630:

### SELECT DESCRIPTION, REVISION_DATE, KPI.ID AS ID_ADDED_{—}0, KPI_DETAILS.ID AS ID_ADDED_{—}1

### FROM KPI_GENERAL as KPI, KPI_DETAILS

### WHERE NAME=‘PRODUCTIVITY’

The ID column of the KPI_General table is referenced as KPI.ID, and not as KPI_GENERAL.ID, due to above-described lookup of the table name/alias data structure. The lookup also results in referencing the ID column of the KPI_Details table as KPI_DETAILS.ID.

Process 700 of FIGS. 7A and 7B may comprise an implementation of S345 and S350 of process 300. Accordingly, process 700 begins after query results corresponding to a modified query are received. Process 700 may therefore be performed by a post-processor such as post-processor 125 according to some embodiments.

A result row of the query results is acquired at S705. The result row includes associated values of each column selected in the query. The query results also include metadata indicating the name of the table and the name of the column from which each value was obtained. If the query referenced a column name and/or a table name using an alias, the metadata will specify the alias rather than the actual column/table name.

For purposes of example, it will be assumed that the query transmitted to a query server at S335 was:

### SELECT DESCRIPTION, REVISION_DATE, KPI.ID AS ID_ADDED 0,

### KPI_DETAILS.ID AS ID_ADDED_{—}1

### FROM KPI_GENERAL as KPI, KPI_DETAILS

### WHERE NAME=‘PRODUCTIVITY’,

and that the first (and only) result row acquired at S705 is: (Revenue per Work Hour', ‘May 31, 2010’, ‘9D9QD8C9AD’, ‘89JCDJ9J9DD’)

A value of a returned column of the result row is obtained at S710. At S715, it is determined whether the column is associated with a text data type or a non-text data type. Process 700 therefore reflects a language conversion implementation, but embodiments are not limited thereto. If the data type is non-text, flow continues to S720 (FIG. 7B) to determine if the row includes additional column values. If so, flow returns to S710 to retrieve a next column value from the row.

Flow proceeds to S725 if the data type of the column is determined to be text at S720. At S725, a table ID associated with the column in the result row is determined. For example, the metadata of the returned result indicates that the value ‘Revenue per Work Hour’ was obtained from the table KPI (i.e., the alias of KPI_General that was used in the query). The metadata also indicates that the value ‘9D9QD8C9AD’ was obtained from the table KPI (i.e., since the ID column was referenced in the query as KPI.ID). Therefore, ‘9D9QD8C9AD’ is determined as the row identifier associated with the value ‘Revenue per Work Hour’.

The returned column name is used at S730 to lookup the actual column name. In this regard, the result metadata does not specify whether the returned column name is an alias or an actual column name. According to some embodiments of S730, the returned column name (e.g., ‘Description’) is used as a key to lookup the actual column name in the lookup table created at S610. As described, the values of this lookup table reflect actual column names although, depending on the query, the associated keys may be either aliases or actual column names.

Based on the query of present example, the following lookup table is created at S610:

| Key | Value |
|---|---|
| Description | Description |
| Revision_Date | Revision_Date |

The actual column name is therefore determined to be ‘Description’ at S730.

A table name associated with the table ID is determined at S735. By virtue of the modified query, the alias ‘ID_Added_{—}0’ is associated with the returned table ID that is associated with the column (i.e., ‘9D9QD8C9AD’). The index ‘0’ specified by the alias may be used to determine the actual table name (KPI_General) from the table list (e.g., tableList) created at S620.

Next, at S740, a translation table lookup is performed using the Table ID, the actual table name and the actual column name. Some embodiments also use a format designator to perform the lookup. In this regard, translation table contains two rows associated with the values ‘KM_General’, ‘9D9QD8C9AD’, and ‘Description’. It will be assumed that the desired format of the converted value is French (e.g., the current user's default language is French). Therefore, a lookup at S740, using the values ‘KPI_General’, ‘9D9QD8C9AD’, ‘Description’, and ‘FR’, fetches the value ‘Revenus par Heure de Travail’.

It is therefore determined at S750 that the lookup resulted in a fetched value. At S755, the fetched value is substituted for the returned column value in the current result row. Accordingly, the result row of the present example is now: (Revenus par Heure de Travail', ‘May 31, 2010’, ‘9D9QD8C9AD’, ‘89JCDJ9J9DD’). Flow then continues to S720 to determine if the result row includes other columns. If the lookup at S740 returned no values (e.g., because translation table 500 includes no row corresponding to the key (KPI_General', ‘9D9QD8C9AD’, ‘Description’, ‘FR’)), then flow would proceed directly from S750 to S720 (i.e., without substituting any value for the returned column value).

If additional columns exist, flow returns to S710 to obtain a value of a next returned column and flow proceeds as described above. Flow continues to S760 if no more columns exist. All added table identifiers (i.e., those which correspond to the ID columns added to the query at S630) are removed from the result row at S760. According to the present example, all values in the result row are removed which correspond to aliases having the form ‘ID_Added_n’. The result row of the present example reads: (Revenus par Heure de Travail', ‘May 31, 2010’) after S760.

At S765, it is determined whether additional result rows exist. If so, flow returns to S705 and continues as described above for a next result row. Once all result rows have been processed by process 700, flow proceeds to S355 to return the result rows (which may or may include substituted values) to the requestor.

The standard SQL sort keyword, ORDER BY, performs a binary sort. However, a binary sort is of limited use in sorting character-based fields. This limitation is particularly pronounced in the case of non-English languages, since the binary sort order does not sort according to the linguistic rules of a specific language. Accordingly, prior to returning the result row to the requestor, some embodiments determine whether a sort was issued in the original the query. If so, the result rows are sorted linguistically prior to being returned to the requestor.

Any number of modifications may be applied to the above-described implementations. For example, optimizations may be implemented to reduce the number of lookups required by a pre-processor and/or by a post-processor. In some embodiments, an additional data structure is provided to define combinations of tables and columns for which converted values exist. The pre-processor/post-processor may determine whether a received query includes any of these combinations before determining to perform the processes described herein.

In the above-described example of process 700, the translated columns for a table row are retrieved using n queries, where n is the number of text columns in the table row. In some embodiments, a translation table is organized such that the post-processor may retrieve all translated columns for a table row in a single query.

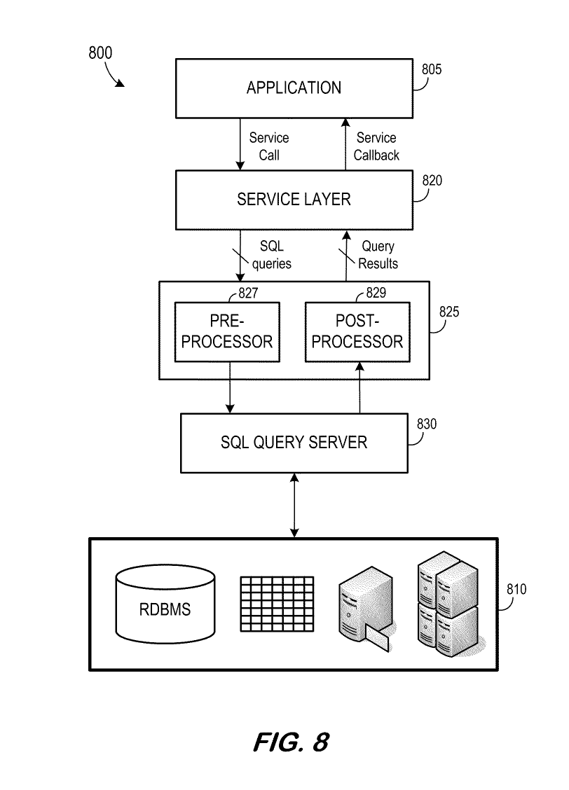

FIG. 8 is a block diagram of system 800 according to some embodiments. System 800 may operate to perform any one or more of the processes described herein. Each element of system 800 may be implemented by any suitable combination of hardware (e.g., one or more processors) and/or software (e.g., processor-executable program code). System 800 may include elements in addition to those illustrated, and some embodiments may omit one or more elements of system 800.

Application 805 may comprise any apparatus and/or application requiring services, such as but not limited to Web services. Application 805 may request such services via a service call to service layer 820. For example, application 805 may call a KPI_Info_Service interface supported by service layer 820 in order to access information relating to one or more KPIs.

Service layer 820 may generate one or more SQL queries in response to the service call. These queries are received by pre-processor 827 of query processor 825. Query processor 825 may, in some embodiments, comprise an element of an auditing object or other module which requires interaction with each query and/or query result.

SQL query server 830 receives queries which may or may not have been modified according to process 300/600 from processor 825. Query server 830 then queries an appropriate one or more of datasources 810 based on the received queries. Embodiments are not limited to the number and types of datasources shown in FIG. 8. Conventional enterprise computing systems may utilize data provided by many disparate sources. These data sources may include one or more relational databases, Online Analytical Processing (OLAP) databases, text files, spreadsheet files, application servers, etc.

Query server 830 may connect to each of datasources 810 via a corresponding software connector. For example, to retrieve data from a datasource, query server 830 transmits an SQL query to the software connector corresponding to the datasource. By using such software connectors, the different data formats and access techniques of the datasources become substantially transparent to query server 830.

Embodiments described herein are solely for the purpose of illustration. Those in the art will recognize other embodiments may be practiced with modifications and alterations to that described above.

What is claimed is:

1. A computer-implemented method comprising:
receiving a structured query language (SQL) query to select one or more values from one or more database tables;
modifying the SQL query to select identifiers of table rows including the selected values;
receiving query results of the modified SQL query, the query results including the selected values and identifiers of table rows including the selected values;
determining converted values corresponding to one or more of the selected values based on the identifiers of table rows including the one or more of the selected values; and
modifying the query results to substitute each of the one or more of the selected values with a corresponding substitute value.

2. A computer-implemented method according to claim 1, wherein modifying the query results comprises:
modifying the query results to remove the identifiers of table rows including the selected values.

3. A computer-implemented method according to claim 1, wherein modifying the SQL query comprises:
determining at least one database table associated with the SQL query; and
adding an identifier (ID) column of each of the at least one database table to the SQL query.

4. A computer-implemented method according to claim 3, further comprising:
determining whether any of the at least one database table is associated with an alias in the SQL query; and
creating a first data structure associating a name of each of the at least one database table which is associated with an alias with its respective alias, and associating a name of each of the at least one database table which is not associated with an alias with itself.

5. A computer-implemented method according to claim 4, further comprising:
determining one or more column names of the SQL query;
determining whether any of the one or more column names is associated with an alias in the SQL query; and
creating a second data structure associating each of the one or more column names which is associated with an alias with its respective alias, and associating each of the one or more column names which is not associated with an alias with itself.

6. A computer-implemented method according to claim 1, wherein determining the converted values corresponding to one or more of the selected values based on the identifiers of table rows comprises:
determining a table row identifier associated with a column value in a row of the query results;
determining a column name associated with the column value in the row of the query results; and
identifying a substitute value in a translation table based on the table row identifier and the column value, and
wherein modifying the query results comprises:
substituting the column value in the row of the query results with the substitute value; and
removing the table row identifier from the row of the query results.

7. A computer-implemented method according to claim 6, wherein determining the converted values corresponding to one or more of the selected values based on the identifiers of table rows further comprises:
determining a table name associated with the table row identifier in the row of the query results; and
identifying the substitute value in the translation table based on the table row identifier, the column value and the table name.

8. A computer-implemented method according to claim 1, further comprising:
determining whether any of the at least one database table is associated with an alias in the SQL query;
creating a first data structure associating a name of each of the at least one database table which is associated with an alias with its respective alias, and associating a name of each of the at least one database table which is not associated with an alias with itself;
determining one or more column names of the SQL query;
determining whether any of the one or more column names is associated with an alias in the SQL query; and
creating a second data structure associating each of the one or more column names which is associated with an alias with its respective alias, and associating each of the one or more column names which is not associated with an alias with itself,
wherein determining the converted values corresponding to one or more of the selected values based on the identifiers of table rows comprises:
determining a table row identifier associated with a column value in a row of the query results;
determining a table name associated with the table row identifier in the row of the query results based on the first data structure;
determining a column name associated with the column value in the row of the query results based on the second data structure; and
identifying a substitute value in a translation table based on the table row identifier, the table name and the column value, and
wherein modifying the query results comprises:
substituting the column value in the row of the query results with the substitute value.

9. A computer-readable medium having stored thereon program code, the program code executable by a processor to:
receive a structured query language (SQL) query to select one or more values from one or more database tables;
modify the SQL query to select identifiers of table rows including the selected values;
receive query results of the modified SQL query, the query results including the selected values and identifiers of table rows including the selected values;
determine converted values corresponding to one or more of the selected values based on the identifiers of table rows including the one or more of the selected values; and
modify the query results to substitute each of the one or more of the selected values with a corresponding substitute value.

10. A computer-readable medium according to claim 9, wherein the program code executable to modify the SQL query comprises program code executable to:
determine at least one database table associated with the SQL query; and
add an identifier (ID) column of each of the at least one database table to the SQL query.

11. A computer-readable medium according to claim 9, wherein the program code executable to determine the converted values comprises program code executable to:
determine a table row identifier associated with a column value in a row of the query results;
determine a column name associated with the column value in the row of the query results; and
identify a substitute value in a translation table based on the table row identifier and the column value, and
wherein the program code executable to modify the query results comprises program code executable to:
substitute the column value in the row of the query results with the substitute value; and
remove the table row identifier from the row of the query results.

12. A computer-readable medium according to claim 9, the program code further executable to:
determine whether any of the at least one database table is associated with an alias in the SQL query;
create a first data structure associating a name of each of the at least one database table which is associated with an alias with its respective alias, and associating a name of each of the at least one database table which is not associated with an alias with itself;
determine one or more column names of the SQL query;
determine whether any of the one or more column names is associated with an alias in the SQL query; and
create a second data structure associating each of the one or more column names which is associated with an alias with its respective alias, and associating each of the one or more column names which is not associated with an alias with itself,
wherein the program code executable to determine the converted values corresponding to one or more of the selected values based on the identifiers of table rows comprises program code executable to:
determine a table row identifier associated with a column value in a row of the query results;
determine a table name associated with the table row identifier in the row of the query results based on the first data structure;
determine a column name associated with the column value in the row of the query results based on the second data structure; and
identify a substitute value in a translation table based on the table row identifier, the table name and the column value, and
wherein the program code executable to modify the query results comprises program code executable to:
substitute the column value in the row of the query results with the substitute value.

13. A system comprising:
a database comprising database tables;
a query server to receive structured query language (SQL) queries on the database tables and to return query results in response to the received SQL queries;
a pre-processor to:
receive an SQL query to select one or more values from one or more of the database tables;
modify the SQL query to select identifiers of table rows including the selected values; and
transmit the modified SQL query to the query server; and
a post-processor to:
receive query results of the modified SQL query from the query server, the query results including the selected values and identifiers of table rows including the selected values;
determine converted values corresponding to one or more of the selected values based on the identifiers of table rows including the one or more of the selected values; and
modify the query results to substitute each of the one or more of the selected values with a corresponding substitute value.

14. A system according to claim 13, wherein modification of the query results comprises:
modification of the query results to remove the identifiers of table rows including the selected values.

15. A system according to claim 13, wherein modification of the SQL query comprises:
determination of at least one database table associated with the SQL query; and
addition of an identifier (ID) column of each of the at least one database table to the SQL query.

16. A system according to claim 15, the pre-processor further to:
determine whether any of the at least one database tables is associated with an alias in the SQL query; and
create a first data structure associating a name of each of the at least one database table which is associated with an alias with its respective alias, and associating a name of each of the at least one database table which is not associated with an alias with itself.

17. A system according to claim 16, the pre-processor further to:
determine one or more column names of the SQL query;
determine whether any of the one or more column names is associated with an alias in the SQL query; and
create a second data structure associating each of the one or more column names which is associated with an alias with its respective alias, and associating each of the one or more column names which is not associated with an alias with itself.

18. A system according to claim 13, wherein determination of the converted values corresponding to one or more of the selected values based on the identifiers of table rows comprises:
determination of a table row identifier associated with a column value in a row of the query results;
determination of a column name associated with the column value in the row of the query results; and
identification of a substitute value in a translation table based on the table row identifier and the column value, and
wherein modification of the query results comprises:
substitution of the column value in the row of the query results with the substitute value; and
removal of the table row identifier from the row of the query results.

19. A system according to claim 18, wherein determination of the converted values corresponding to one or more of the selected values based on the identifiers of table rows further comprises:
determination of a table name associated with the table row identifier in the row of the query results; and
identification of the substitute value in the translation table based on the table row identifier, the column value and the table name.

20. A system according to claim 13, the pre-processor further to:
determine whether any of the at least one database table is associated with an alias in the SQL query;
create a first data structure associating a name of each of the at least one database table which is associated with an alias with its respective alias, and associating a name of each of the at least one database table which is not associated with an alias with itself;
determine one or more column names of the SQL query;
determine whether any of the one or more column names is associated with an alias in the SQL query; and
create a second data structure associating each of the one or more column names which is associated with an alias with its respective alias, and associating each of the one or more column names which is not associated with an alias with itself,
wherein determination of the converted values corresponding to one or more of the selected values based on the identifiers of table rows comprises:
determination of a table row identifier associated with a column value in a row of the query results;
determination of a table name associated with the table row identifier in the row of the query results based on the first data structure;
determination of a column name associated with the column value in the row of the query results based on the second data structure; and
identification of a substitute value in a translation table based on the table row identifier, the table name and the column value, and
wherein modification of the query results comprises:
substitution of the column value in the row of the query results with the substitute value.
